(19) United States
(12) Patent Application Publication
(10) Pub. No.: US 2025/0339738 A1
(43) Pub. Date: Nov. 6, 2025

(54) GUIDING EXERCISE PERFORMANCES USING PERSONALIZED THREE-DIMENSIONAL AVATARS BASED ON MONOCULAR IMAGES

(71) Applicant: Hinge Health, Inc., San Francisco, CA (US)

(72) Inventors: Colin Joseph Brown, Saskatoon (CA); Sohail Zangenehpour, Beaconsfield (CA); Thomas Jan Mahamad, Montreal (CA); Oak Chantosa, Seattle, WA (US)

(21) Appl. No.: 19/270,845

(22) Filed: Jul. 16, 2025

Related U.S. Application Data
(63) Continuation of application No. PCT/US2024/012545, filed on Jan. 23, 2024.
(60) Provisional application No. 63/481,022, filed on Jan. 23, 2023.

(51) Int. Cl. A63B 24/00

(52) U.S. Cl. CPC A63B 24/0062; A63B 24/0075

(57) ABSTRACT

Introduced here are computer-implemented platforms (also referred to as “pose monitoring platforms”) that are designed to improve adherence to, and success of, physical activity programs. As part of a physical activity therapy program, a user may be requested to engage with a pose monitoring platform to follow a program of physical activities. The pose monitoring platform can create an avatar of a user and estimate poses being performed by the user in the real world. The pose monitoring platform can render instances of the avatar in the estimated poses and display the instances of the avatar to guide the user through the program, such as by comparing the instances to rendered instances of the avatar performing poses associated with the physical activities.

### CROSS-REFERENCE TO RELATED APPLICATIONS

This is a continuation of International Application No. PCT/US2024/012545, titled “Guiding Exercise Performances Using Personalized Three-Dimensional Avatars Based on Monocular Images” and filed on Jan. 23, 2024, which claims priority to U.S. Provisional Application No. 63/481,022, titled “Monocular Volumetric Exercise” and filed on Jan. 23, 2023, each of which are incorporated herein by reference in their entirety.

### TECHNICAL FIELD

Various embodiments concern computer programs designed to improve performance of poses with various body parts and associated systems and methods.

### BACKGROUND

Exercise therapy is an intervention technique that utilizes physical activity as the principal treatment method for addressing the symptoms of musculoskeletal (MSK) conditions, such as acute physical ailments and chronic physical ailments. Exercise therapy programs may involve a plan for performing physical activities during exercise therapy sessions that occur on a periodic basis. Generally, the purpose of an exercise therapy program is to either restore normal MSK function or reduce the pain caused by an acute or chronic physical ailment, which may have been caused by injury or disease. As such, the physical activities to be performed in each exercise therapy session may be selected in order to achieve a specific therapeutic goal. Examples of therapeutic goals include lessening pain, improving flexibility, rehabilitating injuries, managing diseases, and the like.

These exercise therapy programs normally depict how a user should perform one or more physical activities to achieve a specific therapeutic goal within a time period. However, these exercise pose monitoring platforms usually are unable to monitor whether the user is properly performing the physical activities or guide the user based on how she is actually performing the physical activities. For example, if the user is not using the proper technique to perform a physical activity, she may not know that her technique is off. This can result in the user not experiencing improvement in her acute or chronic pain, flexibility, or the like, causing the user to become discouraged from doing her exercise therapy sessions. Therefore, a better approach is needed for guiding users through physical activities such that users are able to achieve lasting improvement in terms of MSK function. The benefits of improved performance of poses are not limited to exercise therapy programs.

Other systems that facilitate training a user to perform physical activities may also be unable to monitor whether a user is properly performing a variety of physical activities, such as dance moves, sporting techniques, exercises, cooking techniques, and the like. For example, if a user is not using proper form for her forehands, she may not be as successful in tennis matches compared to if she were using proper form. In another example, a user may be penalized in a cooking competition for not cutting her vegetables in a specific manner, which system could have informed her with the ability to monitor her cutting technique. Thus, these systems need a way to monitor physical activities for users to achieve improved form.

### BRIEF DESCRIPTION OF THE DRAWINGS

FIG. 1 illustrates an example of a network environment that includes a pose monitoring platform.

FIG. 2A illustrates an example of a computing device able to implement a program in which a user is requested to perform physical activities, such as exercises, during sessions by a pose monitoring platform.

FIG. 2B illustrates a processing module of the pose monitoring platform of FIG. 2A.

FIG. 3A depicts an example of a communication environment that includes a pose monitoring platform configured to receive several types of data.

FIG. 3B depicts another example of a communication environment that includes a pose monitoring platform configured to obtain data from one or more sources.

FIG. 4A depicts a flow diagram of a process for updating a rendering of a target instance, according to one embodiment.

FIG. 4B depicts a flow diagram of a process for rendering a second instance of a three-dimensional avatar.

FIG. 5 depicts a flow diagram of a process for comparing a first instance and a second instance.

FIG. 6A is a front view of a user in a T-pose.

FIG. 6B is an isometric view of an instance of an avatar in a T-pose.

FIG. 7 depicts instances of an avatar in a series of poses.

FIGS. 8A is an isometric view of a user in a bent pose.

FIG. 8B is a side view of an instance of an avatar in a bent pose overlayed with an instance of the avatar in a target pose.

FIG. 9 is a block diagram illustrating an example of a processing system.

Various features of the technology described herein will become more apparent to those skilled in the art from a study of the Detailed Description in conjunction with the drawings. Various embodiments are depicted in the drawings for the purpose of illustration. However, those skilled in the art will recognize that alternative embodiments may be employed without departing from the principles of the technology. Accordingly, although specific embodiments are shown in the drawings, the technology is amenable to various modifications.

### DETAILED DESCRIPTION

Introduced here are computer-implemented platforms that are designed to improve adherence to, and success of, care programs that are assigned to users for completion. A care program (or simply “program”) may be designed for one or more musculoskeletal (MSK) conditions. As an example, a program may be designed in an effort to address (e.g., alleviate or lessen) the pain that tends to accompany a given MSK condition, as well as facilitate the continued engagement that is critical for long-term success. Specifically, the program may instruct, prompt, or otherwise elicit performance of physical activities that are meant to improve different aspects of the given MSK condition. Examples of physical activities include exercises, stretches, and the like.

As part of a program, a user may be requested to engage with a computer-implemented platform (also referred to as a “pose monitoring platform”) that is accessible via a computer program executing on a computing device. The term “user” may be used to generally refer to an individual who engages in physical activities via the pose monitoring platform. Over time, the user may be instructed to perform physical activities during physical activity sessions (or simply “sessions”) as part of a program. For example, the user may be instructed to perform a series of physical activities over the course of a session, and the user may be prompted to complete a series of sessions over the course of several days, weeks, or months. The pose monitoring platform may not only assist the user by actively guiding her through each session, but also help her achieve and maintain proper technique in performing the physical activities.

As further discussed below, a pose monitoring platform may represent one part of the physical activity system (or simply “system”) that is designed to promote compliance with a program. Though referred to in relation to therapeutic activities herein, the pose monitoring platform may promote programs with physical activities for a variety of activities beyond healthcare, such as for wellness, sports, dance, virtual reality, augmented reality, cooking, art, or any other endeavor that requires physical activities be performed in a particular manner (or simply benefits from physical activities being performed in a particular manner. More detailed examples of how monitoring pose can be helpful in different contexts are provided below.

Generally, the pose monitoring platform is embodied as a computer program executing on a computing device that is accessible to a user. This computing device may be coupled to one or more image sensors that capture data about the environment surrounding a user. As the user completes physical activities during a session, the computing device sends image data captured by these image sensors to the pose monitoring platform for computer vision analysis. By analyzing this image data, the pose monitoring platform may be able to establish whether the user is performing the physical activities as requested.

Such an approach enables the pose monitoring platform to provide personalized feedback to a user about the physical activities that the user has performed. Moreover, the pose monitoring platform may tailor a program (or individual sessions) based on its knowledge of user movement. For example, if the pose monitoring platform determines that a user struggled to perform a physical activity (e.g., based on determined body poses), then the pose monitoring platform may issue further instructions to the user of how to properly perform the physical activity.

At a high level, the pose monitoring platform is representative of a pathway for digitally engaging persons in a consistent, meaningful way. As further discussed below, other avenues of communication may be employed as well. For example, a coach may be able to interact directly with users (e.g., via text messages, email, video, etc.) in addition to communicating with those users through the pose monitoring platform. The term “coach” may be used to generally refer to individuals who prompt, encourage, or otherwise facilitate engagement by users with programs. Similarly, users could be connected with healthcare professionals such as physical therapists, physicians, nurses, counselors, etc. For example, the pose monitoring platform may generate interfaces through which a coach can serve as a guide, partner, or “cheerleader” for a user as she completes sessions in accordance with a program. Similarly, the pose monitoring platform may generate interfaces through which a healthcare professional can obtain or rely on advice regarding symptoms, treatment, and the like.

As mentioned above, the approaches introduced here for rendering avatar instances based on estimated poses could be used across different applications. Accordingly, while embodiments may be described in the context of healthcare, features of those embodiments may be similarly applicable to other fields related to performing physical activities. Similarly, while embodiments may be described in the context of “coaches,” features of those embodiments may be similarly applicable to other professionals. In addition to, or instead of, facilitating communication with coaches and healthcare professions, the pose monitoring platform could facilitate communication with athletes, athletics coaches, dance instructors, chefs, cooking instructors, art instructors, and the like.

For the purpose of illustration, embodiments may be described with reference to particular anatomical regions, sensor data analysis techniques, pose applications (e.g., dance, therapy, sports, etc.), and the like. However, those skilled in the art will recognize that the features are similarly applicable to other anatomical regions, computer vision techniques, and use cases. As an example, while embodiments may be described in the context of an image sensor that captures image data about the environment around a user, the features described herein may be applied by a physical activity system having any number of image sensors arranged throughout the environment. In fact, a pose monitoring platform may establish the spatial position of different anatomical regions over time and then determine whether those spatial positions indicate that the physical activities were performed properly. For example, an image sensor may be affixed to the top of a television for capturing image data of a user playing a virtual reality game. The pose monitoring platform may be able to infer whether the user dodged monsters in the virtual reality game based on the image data captured by the image sensor. In another example, two image sensor may be placed in a kitchen, one above the island and the other above the stove. The pose monitoring platform may use image data of a user's hands captured by either sensor to determine if a user is using proper technique when chopping and sauteing zucchini. The pose monitoring platform may employ any number of computer vision techniques for determining body poses in these scenarios. Examples of computer vision techniques include image classification, object detection, object tracking, semantic segmentation, and instance segmentation.

Moreover, embodiments may be described in the context of computer-executable instructions for the purpose of illustration. However, aspects of the technology can be implemented via hardware, firmware, or software. As an example, a pose monitoring platform may be embodied as a computer program that offers support for completing sessions as part of a program, enables communication between users and coaches, and determines which physical activities are appropriate for a session given past performance, specified preferences, etc.

### Terminology

References in the present disclosure to “an embodiment” or “some embodiments” mean that the feature, function, structure, or characteristic being described is included in at least one embodiment. Occurrences of such phrases do not necessarily refer to the same embodiment, nor are they necessarily referring to alternative embodiments that are mutually exclusive of one another.

Unless the context clearly requires otherwise, the terms “comprise,” “comprising,” and “comprised of” are to be construed in an inclusive sense rather than an exclusive or exhaustive sense. That is, in the sense of “including but not limited to.”

The term “based on” is also to be construed in an inclusive sense. Accordingly, the term “based on” is intended to mean “based at least in part on” unless the context clearly requires otherwise.

The terms “connected,” “coupled,” and variants thereof are intended to include any connection or coupling between two or more elements, either direct or indirect. The connection or coupling can be physical, logical, or a combination thereof. For example, elements may be electrically or communicatively coupled to one another despite not sharing a physical connection.

The term “module” may refer broadly to software, firmware, hardware, or combinations thereof. Modules are typically functional components that generate one or more outputs based on one or more inputs. A computer program may include or utilize one or more modules. For example, a computer program may utilize multiple modules that are responsible for completing different tasks, or a computer program may utilize a single module that is responsible for completing all tasks.

When used in reference to a list of multiple items, the word “or” is intended to cover all of the following interpretations: any of the items in the list, all of the items in the list, and any combination of items in the list.

### Overview of Pose Monitoring Platform

As discussed above, a pose monitoring platform may be responsible for guiding a user through sessions that are performed as part of a program. As part of the program, the user may be requested to engage with the pose monitoring platform on a periodic basis. The frequency with which the user is requested to engage with the pose monitoring platform may be based on factors such as the anatomical region for which therapy is needed, the MSK condition (or non-healthcare related condition, such as desire to improve technique) for which therapy is needed, the difficulty of the program, the age of the user, the amount of progress that has been achieved, and the like.

As mentioned above, the pose monitoring platform could also estimate pose in contexts that are unrelated to healthcare, for example, to improve technique. For example, the pose monitoring platform may estimate pose of an individual while she completes an athletic activity (e.g., performing a dance move, shooting a basketball, throwing a baseball), a virtual reality activity, an augmented reality activity, a cooking activity, an art activity, etc. Accordingly, while embodiments may be described in the context of a “patient,” the features of those embodiments may be similarly applicable to individuals performing physical activities. These individuals may also be referred to as “participants” of the pose monitoring platform.

Even if the pose monitoring platform is able to request that a user engage at a given frequency, the user will normally have the autonomy to engage with the program as frequently as she desires. Thus, the user may define a schedule for completing sessions (e.g., every day, every other day, or twice per week) as further discussed below, and various features of the pose monitoring platform may be designed in support of this habit formation. Alternatively, the user may complete sessions on an ad hoc basis.

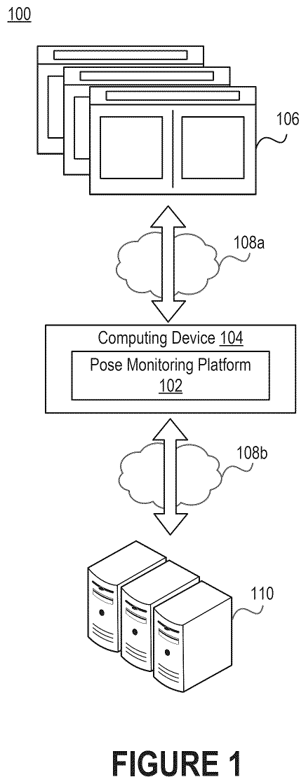

FIG. 1 illustrates an example of a network environment 100 that includes a pose monitoring platform 102 that is executed by a computing device 104. Individuals can interact with the pose monitoring platform 102 via interfaces 106 as further discussed below. For example, participants may be able to access interfaces that are designed to guide them through sessions, present educational content, indicate progression in a program, present feedback from coaches, etc. As another example, coaches may be able to access interfaces through which information regarding completed sessions (and thus program progression) and clinical data can be reviewed, feedback can be provided, etc. Thus, interfaces 106 generated by the pose monitoring platform 102 may serve as informative spaces for participants or coaches, or the interfaces 106 generated by the pose monitoring platform 102 may serve as collaborative spaces through which users and coaches can communicate with one another.

While the term “user” may generally be used to refer to a participant, coaches could also be “users” of the pose monitoring platform 102, for example, in the sense that progress of participants could be monitored through the pose monitoring platform 102, communication with participants could take place through the pose monitoring platform 102, etc.

For the purpose of illustration, interfaces 106 that are designed to be accessed and used by coaches may be part of a “coach module,” while interfaces 106 that are designed to be accessed and used by patients may be part of a “patient module.” Because coaches and patients (also referred to as “participants,” as mentioned above) are representative of users of the pose monitoring platform 102, the coach and patient modules may be called “user modules.” Accordingly, the pose monitoring platform 102 may be able to cause digital presentation of different interfaces 106 to different users to affect different outcomes, facilitate different activities, or provoke different results.

As shown in FIG. 1, the pose monitoring platform 102 may reside in a network environment 100. Thus, the computing device 104 on which the pose monitoring platform 102 is executing may be connected to one or more networks 108a-b. Depending on its nature, the computing device 104 could be connected to a personal area network (PAN), local area network (LAN), wide area network (WAN), metropolitan area network (MAN), or cellular network. For example, if the computing device 104 is a mobile phone, then the computing device 104 may be connected to a computer server (e.g., that is part of a server system 110) via the Internet. As another example, if the computing device 104 is a computer server (e.g., that is part of the server system 110), then the computing device 104 may be accessible to users via respective computing devices that are connected to the Internet via LANs.

Additionally or alternatively, the computing device 104 can be communicatively coupled to other computing devices over a short-range wireless connectivity technology, such as Bluetooth®, Near Field Communication (NFC),

Wi-FiR Direct (also referred to as “Wi-Fi P2P”), and the like. Assume, for example, that the pose monitoring platform 102 is embodied as a mobile application that is executable by a mobile phone or tablet computer. In such a scenario, the mobile phone or tablet computer may be communicatively connected to (i) one or more sensor units via a short-range wireless connectivity technology and (ii) a computer server via the Internet. As another example, the mobile phone or tablet computer may be communicatively connected to (i) a wearable electronic device—such as a watch or fitness tracker—via a short-range wireless connectivity technology and (ii) a computer server via the Internet.

The interfaces 106 may be accessible via a web browser, desktop application, mobile application, or another form of computer program. For example, a user may be able to access interfaces that are designed to guide her through a session in which predetermined physical activities (e.g., exercises) are to be performed a predetermined number of times via a mobile application that is executing on a mobile phone or tablet computer. As another example, a coach may be able to access interfaces through which she can review the progress of one or more users via a web browser executing on a tablet computer or laptop computer. As another example, a coach may be able to access interfaces through which she can personalize users' sessions based on, for example, their needs and progress. Accordingly, the interfaces 106 may be accessible to various computing devices depending on the nature of the pose monitoring platform 102 and its deployment. Examples of computing devices include desktop computers, laptop computers, tablet computers, mobile phones, wearable electronic devices (e.g., watches or fitness accessories), network-connected electronic devices (e.g., televisions or home assistant devices), virtual reality systems, augmented reality systems, and the like.

Generally, the pose monitoring platform 102 is hosted, at least partially, on the computing device 304 that is responsible for generating digital images to be analyzed and presenting analyses of the digital images, as further discussed below. For example, the pose monitoring platform 102 may be embodied as a mobile application executing on a mobile phone or tablet computer. In such embodiments, the instructions that, when executed, implement the pose monitoring platform 102 may reside largely or entirely on the mobile phone or tablet computer. Note, however, that the mobile application may be able to access a server system 110 on which other components of the pose monitoring platform 102 are hosted.

In some embodiments, the pose monitoring platform 102 is executed entirely by a cloud computing service operated by, for example, Amazon Web Services®, Google Cloud Platform™, or Microsoft Azure®. Accordingly, the computing device 104 may be representative of a computer server that is part of a server system 110. Often, the server system 110 is comprised of multiple computer servers. These computer servers can include information regarding different programs, sessions, or physical activities; computer-implemented models (or simply “models”) that indicate how anatomical regions should move when a given physical activity is performed; algorithms for processing data from which spatial position or orientation of anatomical regions can be computed, inferred, or otherwise determined; user data such as name, age, weight, ailment, enrolled program, duration of enrollment, number of sessions completed, and correspondence with coaches; and other assets.

Those skilled in the art will recognize that this information could also be distributed amongst a network-accessible server system and one or more computing devices. For example, some user data may be stored on, and processed by, her own computing device for security and privacy purposes. This information may be processed (e.g., encrypted or obfuscated) before being transmitted to the server system 110. As another example, some user data may be retrieved from an electronic health record (also referred to as an “electronic medical record”) that is maintained for the user. Electronic health records are normally maintained in storage that is managed by healthcare systems, and this storage may be accessible to the pose monitoring platform 102 (e.g., via an application programming interface). As another example, the algorithms and models needed to process the data from which the spatial position or orientation of anatomical regions of a given individual can be computed, inferred, or otherwise determined may be stored on, or accessible to, a computing device associated with the given individual to ensure that such data can be processed in real time (e.g., as physical activities are performed as part of a session). The data could be generated by one or more sensor units that are secured to the human body of the given individual (e.g., proximate to the anatomical regions), or the data could be generated by a camera that is included in, or accessible to, the computing device used by the given individual to initiate the session.

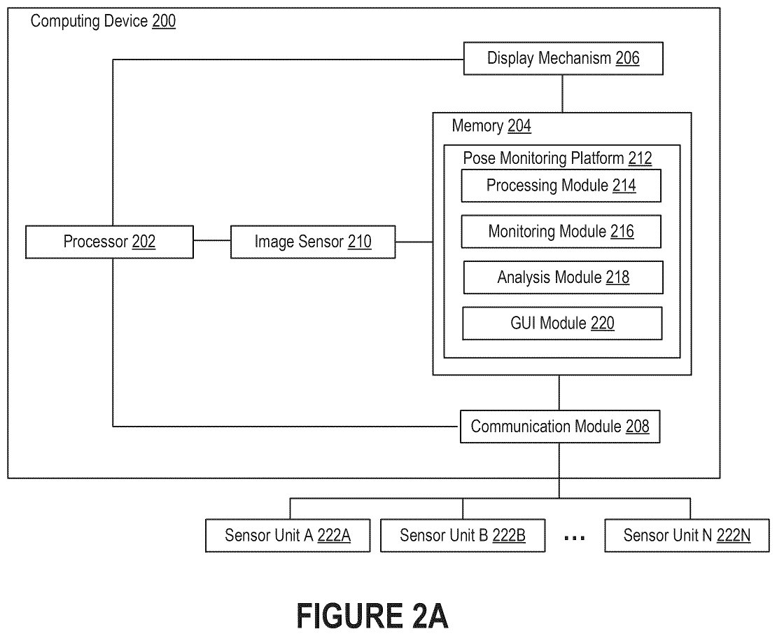

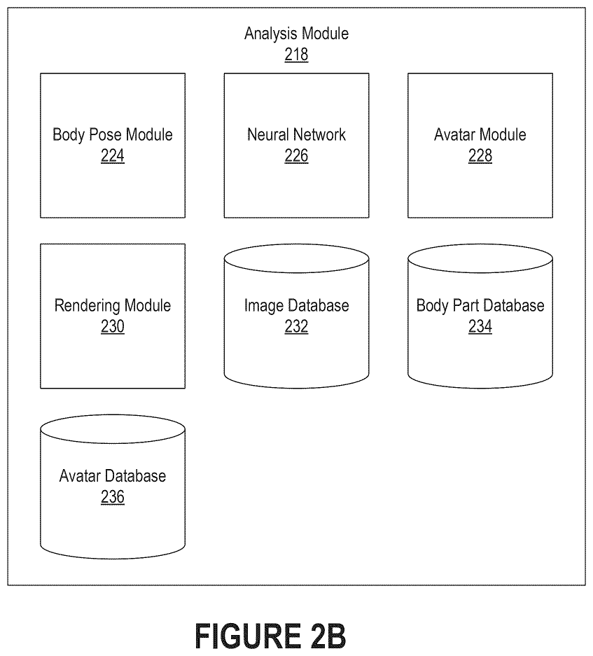

FIG. 2A illustrates an example of a computing device 200 that is able to implement a program in which a user is requested to perform physical activities, such as exercises, during sessions by a pose monitoring platform 212. In some embodiments, the pose monitoring platform 212 is embodied as a computer program that is executed by the computing device 200. In other embodiments, the pose monitoring platform 212 is embodied as a computer program that is executed by another computing device (e.g., a computer server) to which the computing device 200 is communicatively connected. In such embodiments, the computing device 200 may transmit data captured by the image sensor 210 to the other to the other computing device for processing. Those skilled in the art will recognize that aspects of the computer program could also be distributed amongst multiple computing devices.

The computing device 200 can include a processor 202, memory 204, display mechanism 206, communication module 208, and image sensor 210. Each of these components is discussed in greater detail below. Those skilled in the art will recognize that different combinations of these components may be present depending on the nature of the computing device 200.

The processor 202 can have generic characteristics similar to general-purpose processors, or the processor 202 may be an application-specific integrated circuit (ASIC) that provides control functions to the computing device 200. As shown in FIG. 2A, the processor 202 can be coupled to all components of the computing device 200, either directly or indirectly, for communication purposes.

The memory 204 may be comprised of any suitable type of storage medium, such as static random-access memory (SRAM), dynamic random-access memory (DRAM), electrically erasable programmable read-only memory (EEPROM), flash memory, or registers. In addition to storing instructions that can be executed by the processor 202, the memory 204 can also store data generated by the processor 202 (e.g., when executing the modules of the pose monitoring platform 212) and produced, retrieved, or obtained by the other components of the computing device 200. For example, data received by the communication module 208 from the image sensor 210 (e.g., via the processor 202) or sensor units 222A-N may be stored in the memory 204, or data produced by the image sensor 210 may be stored in the memory 204. Note that the memory 204 is merely an abstract representation of a storage environment. The memory 204 could be comprised of actual memory integrated circuits (also referred to as “chips”).

The display mechanism 206 can be any mechanism that is operable to visually convey information to a user (e.g., a user). For example, the display mechanism 206 may be a panel that includes light-emitting diodes (LEDs), organic LEDs, liquid crystal elements, or electrophoretic elements. In some embodiments, the display mechanism 206 is touch sensitive. Thus, a user may be able to provide input to the pose monitoring platform 212 by interacting with the display mechanism 206.

The communication module 208 may be responsible for managing communications between the components of the computing device 300, or the communication module 208 may be responsible for managing communications with other computing devices (e.g., sensor units 220A-N of FIG. 2A or server system 110 of FIG. 1). The communication module 208 may be wireless communication circuitry that is designed to establish communication channels with other computing devices. Examples of wireless communication circuitry include chips configured for Bluetooth, Wi-Fi, NFC, and the like. Assume, for example, that the computing device 200 is associated with a user. In such a scenario, the communication module 208 may initiate and then maintain a communication channel with a network-accessible server system managed by a digital service that is responsible for enrolling and then engaging users in programs. Moreover, the communication module 208 may initiate and then maintain communication channels with one or more external image sensors and/or one or more sensor units 222A-N that are secured to different anatomical regions of the user. As further discussed below, data generated by these components may be streamed to the pose monitoring platform 212 during a session for analysis.

The image sensor 210 may be any electronic sensor that is able to detect and convey information in order to generate images, generally in the form of image data or pixel data. Examples of image sensors include charge-coupled device (CCD) sensors and complementary metal-oxide semiconductor (CMOS) sensors. The image sensor 210 may be implemented in a camera that is implemented in the computing device 200. In some embodiments, the image sensor 210 is one of multiple image sensors implemented in the computing device 200. For example, the image sensor 210 could be included in a front-or rear-facing camera on a mobile phone. In some embodiments, the image sensor may be externally connected to the computing device 200 such that the image sensor 210 captures image data of an environment and sends the image data to the processing module 214.

For convenience, the pose monitoring platform 212 may be referred to as a computer program that resides within the memory 204. However, the pose monitoring platform 212 could be comprised of software, firmware, or hardware implemented in, or accessible to, the computing device 200. In accordance with embodiments described herein, the pose monitoring platform 212 may include a processing module 214, monitoring module 216, analysis module 218 and graphical user interface (GUI) module 220. These modules can be an integral part of the pose monitoring platform 212. Alternatively, these modules can be logically separate from the pose monitoring platform 212 but operate “alongside” it. Together, these modules may enable the pose monitoring platform 212 to guide a user through sessions that are performed as a part of a program designed to improve performance of one or more physical activities or manage/treat an MSK condition that is affecting a particular anatomical region.

The processing module 214 can process image data obtained from the image sensor 210 over the course of a session. The image data may be used to infer a spatial position or orientation of the corresponding anatomical region. For example, the processing module 214 may perform operations (e.g., filtering noise, changing contrast, reducing size) to ensure that the data can be handled by the other modules of the pose monitoring platform 212. As another example, the processing module 214 may temporally align the data with data obtained from another source (e.g., the sensor units 222A-N or another image sensor) if multiple data are to be used to establish the spatial position or orientation of the anatomical regions of interest.

In some embodiments, the processing module 214 additionally or alternatively processes data obtained from sensor units 222A-N attached to anatomical regions of the user over the course of the session. The processing module 214 can parse, filter or otherwise alter this data so that it is usable by the other modules of the pose monitoring platform 212. As an example, the processing module 214 may examine this data to ensure that multiple streams of data received from different components (e.g., Sensor Unit A 222A and Sensor Unit B 222B) are temporally aligned with one another. Moreover, the processing module 214 may examine this data to ensure that each stream of data is properly associated with, or attributed to, a corresponding anatomical region. For example, the processing module 214 may parse metadata that accompanies the streams of data received from Sensor Units A-N 222A-N to ensure that each stream of data programmatically corresponds to a different anatomical region, such that the streams of data can be analyzed in a comprehensible manner.

Moreover, the processing module 214 may be responsible for processing information input by users through interfaces generated by the GUI module 220. For example, the GUI module 220 may be configured to generate a series of interfaces that are presented in succession to a user as she completes physical activities as part of a session. On some or all of these interfaces, the user may be prompted to provide input. For example, the user may be requested to indicate (e.g., via a verbal command or tactile command provided via, for example, the display mechanism 206) that she is ready to proceed with the next physical activity, that she completed the last physical activity, that she would like to temporarily pause the session, etc. These inputs can be examined by the processing module 214 before information indicative of these inputs is forwarded to another module.

The monitoring module 216 can monitor ongoing movement of the user as she completes physical activities as part of a session. While the processing module 214 may be responsible for processing data streamed to the pose monitoring platform 212 (e.g., by the image sensor 210 or, in some embodiments, the sensor units 222A-N), the monitoring module 216 may be responsible for determining whether the user is moving as would be expected when completing a physical activity. As an example, assume that the imager sensor 210 is positioned in front of a user. During a session, the user may be instructed to perform an exercise such as a side plank in which the hips are lifted away from the ground. In such a scenario, the monitoring module 216 can examine image data generated by the image sensor 210 to determine whether the thorax and lumbar regions of the user's body are moving-either in terms of three-dimensional (3D) space or with respect to one another-as would be expected given the exercise.

The analysis module 218 may be responsible for determining adherence to individual physical activities, sets of physical activities performed during sessions, or sets of sessions performed as part of a program. As shown in FIG. 2B, the analysis module 218 can include a body pose module 224, a neural network 226, an avatar module 228, a rendering module 230, an image database 232, a body part database 234, and an avatar database 236. In some embodiments, the analysis module 218 may include a subset of the modules and data structures shown in FIG. 2B, or the analysis module 218 may include additional modules or data structures that are not shown in FIG. 2B.

Those skilled in the art will also recognize that these modules and data structures-while described in the context of the analysis module 218-could be located elsewhere in the pose monitoring platform 212 or computing device 200. For example, the image database 232, body part database 234, or avatar database 236 could be maintained in the memory 204 separate from, but accessible to, the pose monitoring platform 212, or the image database 232, body part database 234, or avatar database 236 could be maintained in a memory that is external to the computing device 200 and accessible via the communication module 208.

The body pose module 224 may be responsible for determining estimated poses of body parts as users perform physical activities. An estimated pose is a combination of postures and positions of the user's body parts at a given time. Body parts may include any portion of a user's body used to perform a physical activity (e.g., hands, feet, torso, etc.). A body part may refer to a single anatomical region (e.g., a hand), one anatomical region in relation to another anatomical region (e.g., a hand in relation to an elbow), or a series of anatomical regions in relation to another anatomical region (e.g., fingers of a hand). Physical activities may include movements performed for wellness, sports, dance, virtual reality experiences, augmented reality experiences, physical therapy, or any other activity that requires physical movement. Some examples of physical activities include dance moves (e.g., pliés, moonwalks, shuffles, etc.), sporting techniques (e.g., football throws, soccer kicks, tennis serves, basketball layups, yoga poses, etc.), exercises (e.g., planks, hip extensions, etc.), stretches, posture techniques (e.g., standing/sitting at desk for healthy back and neck), and cooking techniques (e.g., chopping, kneading, dicing, etc.).

The body pose module 224 can obtain image data of a user performing physical activities from the image sensor 210. The body pose module 224 can do so in response to receiving a request for estimated pose(s) from the rendering module 230. The request can include a physical activity that the user is performing. In some embodiments, the image data may depict the user's entire body. In other embodiments, the image data may depict one or more of the user's body parts. For example, in one embodiment, the image data may only depict the hands and feet of the user. In some embodiments, the image data may depict body parts of multiple users. The body pose module 224 may store the image data in the image database 232 along with an indication of a time, date, or location associated with the capture of the image data.

In some embodiments, the image database 232 may be implemented on a computing device 200 where the image sensor 210 is located. In other embodiments, the image database 232 may be implemented in the server system of FIG. 1. The image database 232 may be formatted to expedite pose analysis by the analysis module 218. For example, in some instances, the image database 232 may be tabulated by identifiers associated with the particular image sensor 210 that capture the image data, identifiers of the users depicted in or otherwise associated with the image data, and/or identifiers of a computing device 200 that transmitted the image data to the analysis module 218.

The body pose module 224 can apply a motion engine to determine estimated poses and/or movements of the user as depicted by the image data. The motion engine can be a 3D pose estimation engine, a motion capture device, or a motion sensor unit. The body pose module 224 can also determine estimated poses and/or movements based on feature maps of the image data. For instance, the body pose module 224 can extract one or more feature maps from the image data. In one embodiment, the body pose module 224 segments the image data into contiguous regions of pixels. Each contiguous region of pixels may be associated with a portion of the environment. In some embodiments, the body pose module 224 segments the image data based on objects shown in the image data. For example, the body pose module 224 may extract pixels representing the floor into a first region, a piece of furniture into a second region, a user's right hand into a third region. In another embodiment, the body pose module 224 segments the image data based on contrast between colors of and/or distance between the pixels. The body pose module 224 may use one or more machine learned models to segment the image data or may use an algorithm. For example, pixels representing a hand may have similar coloring and be within a set distance threshold of one another compared to pixels of a green wall behind the hand. The body pose module 224 may create groups of pixels each associated with a color range (e.g., light to dark green or dark yellow to light orange). For each group, the body pose module 224 may determine a weighted average location of the pixels and remove pixels from the group that are a threshold distance away from the weighted average location. The body pose module 224 may iterate upon this grouping process until every pixel is associated with a group (e.g., a segment of the image data).

The body pose module 224 can extract a feature map for each segment of the image data. A feature map is a vectorial representation of features in the image data. The body pose module 224 may extract feature maps by applying filters or feature detectors to each segment. For example, the body pose module 224 may apply a filter that detects skin to a segment and may receive, as output, a feature map highlighting which portions of the segment include skin. The body pose module 224 may store the segments and associated feature maps in the image data structure 228 or another datastore.

The body pose module 224 can apply the neural network 226 to each extracted feature map. The neural network 226 may include a series of convolutional layers and a series of connected layers of decreasing size and the last layer of the neural network 226 may be a sigmoid activation function. The neural network 226 can include a plurality of parallel branches that are configured to together estimate poses of body parts based on the feature maps. A first branch of the neural network 226 could be configured to determine a likelihood that the portion of the environment associated with the segment includes a body part, while a second branch of the neural network 226 could be configured to determine an estimated pose of the body part in the portion of the environment associated with the segment. Approaches to designing, training, and implementing neural networks with parallel branches is further discussed in U.S. Provisional Application No. 63/370,467, titled “Hand Presence Detection for Hand Pose Estimation,” which is incorporated by reference herein in its entirety. In some embodiments, the body pose module 224 may employ an additional or alternative machine-learning or artificial intelligence framework to the neural network 226 to estimate poses of body parts.

For each extracted feature map, the body pose module 224 determines an estimated pose based on an output from the neural network 226. In some embodiments, the neural network may also output a particular body pose from a set of body poses stored at the body part database 234. In other embodiments, the neural network can output a set of likelihoods each indicative of whether the extracted feature map represents a particular body pose. The body pose module 224 may select the body pose with the highest likelihood from the set as the estimated pose. For multiple extracted feature maps input to the neural network together, the body pose module 224 may determine an estimated pose for each extracted feature map and determine a total pose based on the estimated poses. For example, the body pose module may determine that four extracted feature maps together show that the user is in a star pose (e.g., arms and legs extended diagonally outward from the torso). The body pose module 224 sends the estimated pose(s) to the rendering module 230. For more than one estimated pose, the body pose module orders the estimated poses based on the order the user performed the estimated poses in the image data.

In some embodiments, for each estimated pose, the body pose module 224 determines a physical activity associated with the estimated pose(s). For instance, the body pose module 224 may access physical activities related to poses stored in the body part database 234. For example, the pose “left-handed fist” may be associated with the physical activities “kickboxing jab,” “volleyball serve,” “hand therapy fist,” and “cooking utensil hold.” The body pose module 224 may access user data associated with the user (e.g., stored in memory of the pose monitoring platform 212 or accessed via a network by the pose monitoring platform 212). The body pose module 224 can select a physical activity from among the physical activities associated with the estimated pose(s) based on the user's data and/or overlap in physical activities associated with the estimated pose(s). For example, if the user's data indicates that she is undergoing therapy for her hand and all of the estimated poses are associated with “hand therapy fist,” the body pose module 224 may select the physical activity “hand therapy fist.” The body pose module 224 sends the selected physical activity to the rendering module 230 in response to a request from the rendering module 230.

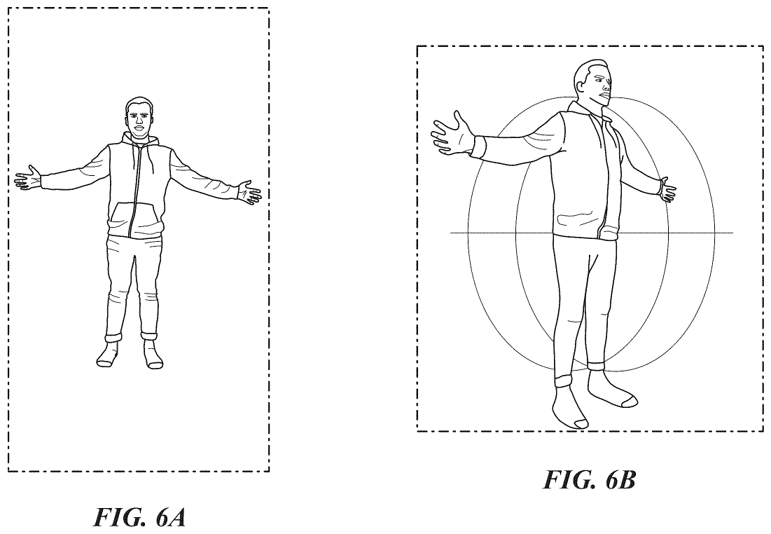

The avatar module 228 creates avatars of users performing physical activities using the pose monitoring platform 212. The avatar module 228 receives image data of a user from the image sensor 210 and stores the image data in the image database 232. Alternatively, the avatar module 228 retrieves the image data from the image database 232. The image data may be a digital image, a series of digital images, video data, or the like. The image data depicts the user in a predetermined pose. The predetermined pose is a particular position that the user places her body in. For example, a predetermined pose may be a T-pose (e.g., where the user stands up with her arms sticking out horizontally to her sides), as shown in FIGS. 6A-6B. The image data may be labeled or otherwise associated with an identifier of the user and an identifier of the predetermined pose.

The avatar module 228 uses the image data to construct an avatar of the user. The avatar may be a two-dimensional (2D) or 3D representation of the user or of the user's skeleton. For instance, the avatar of the user may look like a digital version of the user. The avatar module 228 may use a capture engine to construct the avatar. The capture engine may also be referred to as a monocular volumetric capture (MVC) engine that captures images and/or depth data of an environment and extracts data for creating an avatar of a user. The images and depth data may be captured via a camera with a monocular lens. The capture engine can be external to the computing device 200 of the image sensor 210 and can be a body scanner, a light detection and ranging (LIDAR) system, or a multi-shot 3D reconstruction system. The capture engine can create a surface mesh of the image data. The surface mesh is a set of polygons that connect together to cover the portion of the image data depicting the user. The capture engine also determines texture of the user's body using texture synthesis methods, such as by forming a mesh hierarchy or by creating a 3D texture mesh on the surface mesh. The avatar module 228 automatically rigs (e.g., uses a 3D animation technique) the surface mesh to create lifelike movement in the virtual representation of the user represented in the surface mesh. The avatar module 228 stores the avatar in the avatar database 236 in association with an identifier of the user.

The rendering module 230 creates and updates interfaces for display via the display mechanism 206. The display mechanism 206 can be a physical display on a computing device 200 or can be embedded in an application on the computing device 200. The interfaces may be graphic user interfaces (GUIs). The rendering module 230 may create an interface that a user can interact with (via the display mechanism 206) to perform physical activities as part of a session hosted by the pose monitoring platform 212. For example, the rendering module 230 may create and transmit interfaces that guide a user through a Pilates workout, a virtual cooking class, or a physical therapy session. The interfaces may include the user's avatar performing the physical activities with proper form such that the user can see how her body needs to move to perform the physical activities.

The rendering module 230 receives indications from the display mechanism to render interfaces for users. The rendering module 230 can create interfaces that show textual or visual descriptions of physical activities, including an instance of an avatar of a user depicting a particular body pose. An indication can include an identifier of a user using the pose monitoring platform 212 and a selection of one or more physical activities or estimated poses for the user to perform. For example, the indication may indicate that Arianna wants to use the pose monitoring platform to guide her through lunges and squats for a workout.

The rendering module 230 accesses the user's avatar from the avatar database 236. The rendering module 230 renders an instance of the avatar based on a pose associated with one of the physical activities, further described below. The rendering module 230 can select the first physical activity associated with the indication or can select one of the physical activities based on an ordering indicated by the indication. The rendering module 230 renders a target instance of the avatar in the pose of the selected physical activity. The target instance shows the user's avatar in a starting pose for the physical activity, which the user is to replicate in the real world. In some embodiments, the rendering module 230 renders the target instances to show the avatar performing a series of poses that form the physical activity. The rendering module 230 adds the target instance to the interface and can include in the interface other information about the physical activity, such as its name, tips for performing the physical activity, and the like. The rendering module 230 transmits the interface to the display mechanism 206 for display.

The rendering module 230 requests image data of the user from the image sensor 210. The rendering module 230 can also access image data from the image database 232. The image data can be real-time video data or digital images and depicts the environment of the user as moves. The rendering module 230 sends the image data to the body pose module 224 in a request for estimated pose(s) being performed by the user based on the image data. In some embodiments, such as when the image data is video data, the rendering module 230 can segment the image data into a set of digital images and sends each digital image with a request to the body pose module 224 for an estimated pose associated with the respective digital image.

For each request, the rendering module 230 receives an estimated pose from the body pose module 224. The rendering module 230 can also receive a set of estimated poses with requests. The estimated pose can be represented by a textual name or example visual data (e.g., a reference avatar in the estimated pose) and can be associated with movements (e.g., directions of motion, such as forward right, vertical, etc.) of one or more body parts that a user would do to perform the estimated pose. Estimated poses in a set of estimated poses can represent a physical activity in that the estimated poses performed sequentially represent a physical activity. The rendering module 230 accesses the user's avatar in the avatar database 236 and configures an instance of the avatar into the estimated pose. For instance, for the estimated pose “lunge with right leg back,” the rendering module 230 can render an instance of Kiana's avatar to be performing a lunge with her right leg. Though the instance of the avatar would be virtual, the instance of the avatar would look like Kiana as she was performing a right leg lunge in the real world. The rendering module 230 transmits data representing the instance of the avatar for display via the display mechanism 206. The rendering module 230 can store the data in the avatar database 236 in association with the avatar.

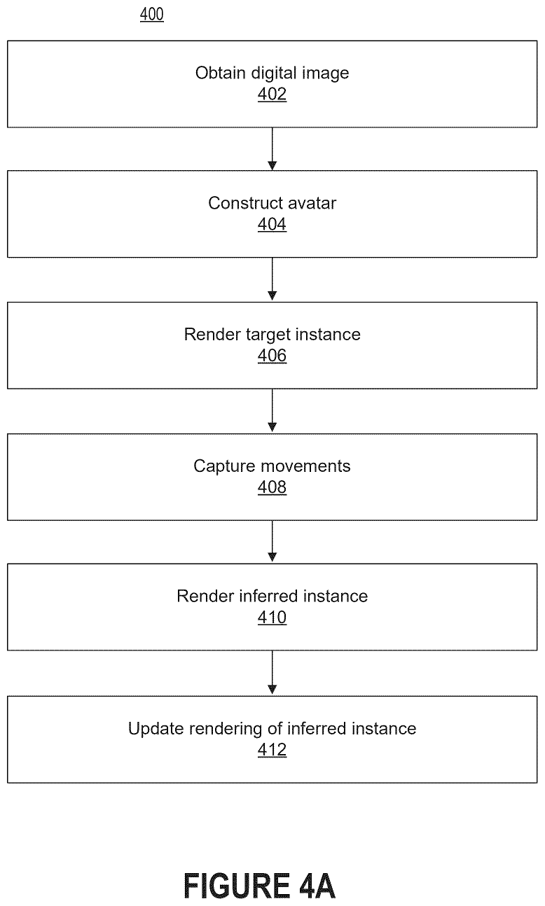

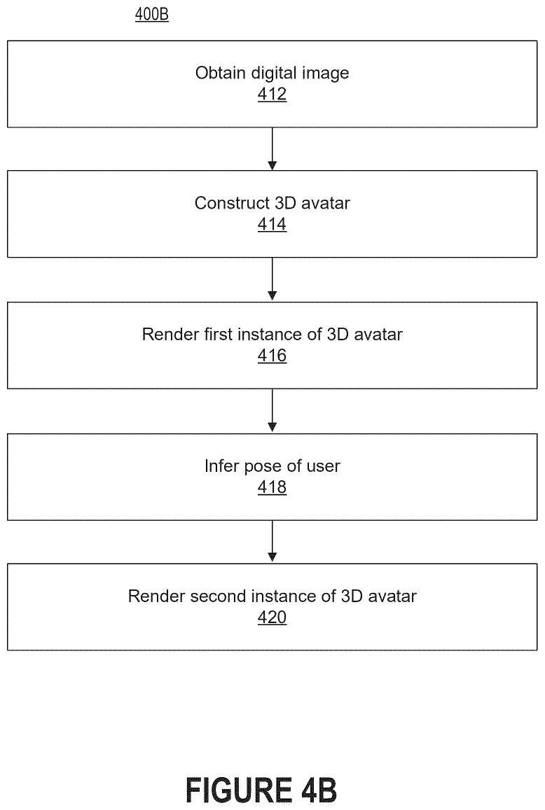

The rendering module 230 can render the instance of the user's avatar to be static or dynamic based on the estimated pose. For example, the rendering module 230 can render the instance of Kiana's avatar to be static by staying positioned in the estimated pose. In some cases, the rendering module 230 can render a dynamic instance of Kiana's avatar by rendering the instance to depict one or more movements associated with the estimate pose. For example, the instance of Kiana's avatar can be depicted transitioning between a starting pose (e.g., an A-pose or a T-pose, which are described in relation to FIG. 4A) and the estimated pose using the one or more movements. The movement of the instance of Kiana's avatar display the proper technique Kiana should follow to perform a physical activity associated with the estimated pose in the real world. The rendering module 230 can render instances of avatars as static or dynamic based on user input or settings indicating a preference between static and dynamic.

The rendering module 230 can also render an instance of an avatar to match a user's pose and/or movement in the real world based on real-time image data. For example, the rendering module 230 retrieves the image data from the image database 232 or receives the image data in real-time from the image sensor 210. The rendering module 230 sends a request to the body pose module 224 for the pose(s) depicted by the image data. The rendering module 230 receives an estimated pose(s) from the body pose module 224. The rendering module 230 can also receive a physical activity associated with the estimated pose(s) from the body pose module 224. The rendering module 230 accesses an avatar of the user from the avatar database 236 and renders an instance(s) of the avatar into the estimated pose(s).

The rendering module 230 causes the display mechanism 206 to display the instance(s) of the avatar in the estimated pose(s). The rendering module 230 can cause the display mechanism 206 to display the instance(s) of the avatar in the estimated pose(s) sequentially. The rendering module 230 can also render the instance(s) of the avatar to move between estimated poses using movements associated with each estimated pose or based on movements associated with the physical activity. For example, the rendering module 230 can cause the display mechanism 206 to display the instance of the avatar performing the estimated pose(s) using movement(s) associated with the estimated pose(s) to show how the user is moving in the real world.

The rendering module 230 can compare estimated poses and associated movements with the physical activity to determine whether the user is properly (e.g., accurately) performing the physical activity. The rendering module 230 accesses the poses and movements associated with the physical activity selected by the body pose module 224 and/or with a physical activity associated with an indication received via the display mechanism. The poses and movements can be ordered based on the physical activity is performed. The rendering module 230 compares the ordered poses to the estimated poses as ordered by the body pose module 224. For instance, the rendering module 230 can compute a comparison measure based on the position information, including the ordered poses and estimated poses, related movements, underlying skeleton joint positions and/or bone angles, and avatar volume. The comparison measure can be of absolute deviation or squared deviation and can be intersection over union of the position information. The rendering module 230 can transmit the comparison measure to an external computing device of a professional associated with the user, such as a coach or healthcare professional, such as a nurse, physical therapist, or doctor.

For a comparison score below a threshold, the rendering module 230 may alter a session being hosted by the pose monitoring platform 212. For instance, the rendering module 230 can prevent further progression through a session until the physical activity is determined to have been performed properly (e.g., the estimated poses match the poses stored with the physical activity). In another example, the rendering module 230 can update the session based on the estimated pose to further teach the user how to perform the pose for the physical activity. The rendering module 230 can also update the session to focus on a different physical activity. The rendering module can cause the display mechanism 206 to display instances based on the updated session and/or a virtual element representative of the comparison score.

The rendering module 230 can also render instance of avatars depicting how the user is performing the physical activity in the real world (e.g., inferred instances) and how the user should perform the physical activity with proper technique (e.g., target instances). For example, the rendering module 230 can render a first instance showing the avatar in the estimated pose and its associated movement and a second instance showing the avatar in the correct pose and its associated movement. The rendering module 230 can also render the first instance to show the avatar in estimated poses performed by the user and the second instance to show the avatar in poses of the physical activity. The rendering module 230 causes the display mechanism 206 to display the first and second instances at the same time or sequentially. The rendering module 230 can also cause the display mechanism 206 to display the target instance and the inferred instance in the same visual space, such the that target instance and inferred instance are overlaid on one another. For example, the target instance and the inferred instance can each include reference points located at the same body part of the avatar, such as at the belly button. The rendering module 230 aligns the target instance and the inferred instance based on the reference points and rotates one of the instances to align current poses of the target instance and the inferred instance.

The rendering module 230 can cause the display mechanism 206 to display additional data related to the user, estimated pose(s), physical activity, movement(s), and the like. For instance, the rendering module 230 can access instructions in the body part database 234 that describe how the user could improve her technique (e.g., to achieve a therapeutic goal) for the physical activity, an estimated pose, or a movement. The rendering module 230 can cause the display mechanism 206 to display the instructions along with one or more instances of the avatar of the user. For example, if the rendering module 230 determines that, while kickboxing, the user is posing her hand in a fist with her thumb enclosed by her fingers, the rendering module 230 may cause the display mechanism 206 to display instructions for the user move her thumb to rest on the outside of her fingers and depict her avatar performing the poses associated with the instructions.

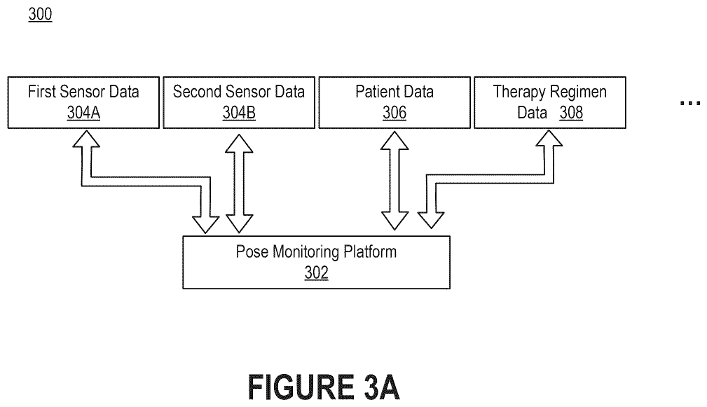

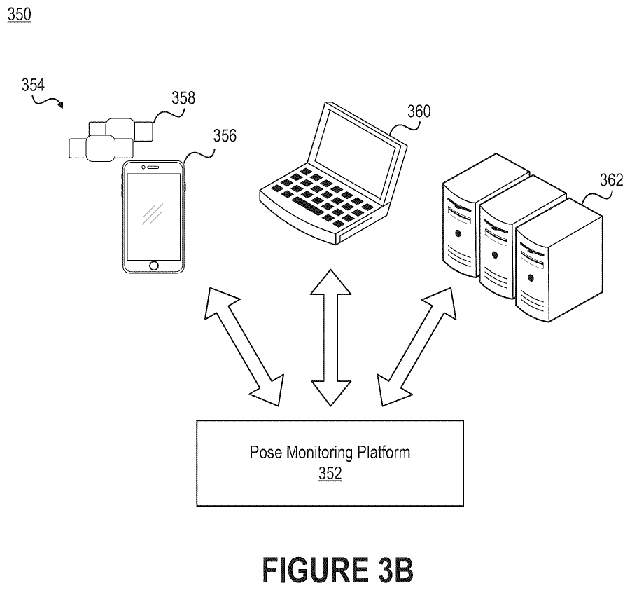

FIG. 3A depicts an example of a communication environment 300 that includes a pose monitoring platform 302 configured to receive several types of data. Here, for example, the pose monitoring platform 302 receives first image data 304A that captured by a first image sensor 210 located in front of a user, second image data 304B generated by an image sensor 210 located behind a user, user data 306 that is representative of information regarding the user, and therapy regimen data 308 that is representative of information regarding the program in which the user is enrolled. Those skilled in the art will recognize that these types of data have been selected for the purpose of illustration. Other types of data, such as community data (e.g., information regarding adherence of cohorts of users), could also be obtained by the pose monitoring platform 302.

These data may be obtained from multiple sources. For example, the therapy regimen data 308 may be obtained from a network-accessible server system managed by a digital service that is responsible for enrolling and then engaging users in programs. The digital service may be responsible for defining the series of physical activities to be performed during sessions based on input provided by coaches. As another example, the user data 306 may be obtained from various computing devices. For instance, some user data 306 may be obtained directly from users (e.g., who input such data during a registration procedure or during a session), while other user data 306 may be obtained from employers (e.g., who are promoting or facilitating a wellness program) or healthcare facilities such as hospitals and clinics. Additionally or alternatively, user data 306 could be obtained from another computer program that is executing on, or accessible to, the computing device on which the pose monitoring platform 302 resides. For example, the pose monitoring platform 302 may retrieve user data 306 from a computer program that is associated with a healthcare system through which the user receives treatment. As another example, the pose monitoring platform 302 may retrieve user data 306 from a computer program that establishes, tracks, or monitors the health of the user (e.g., by measuring steps taken, calories consumed, or heart rate).

FIG. 3B depicts another example of a communication environment 350 that includes a pose monitoring platform 352 configured to obtain data from one or more sources. Here, the pose monitoring platform 352 may obtain data from a therapy system 354 comprised of a tablet computer 356 and one or more sensor units 358 (such as image sensors), personal computer 360, or network-accessible server system 362 (collectively referred to as the “networked devices”). For example, the pose monitoring platform 352 may obtain data regarding movement of a user during a session from the therapy system 354 and other data (e.g., therapy regimen information, models of exercise-induced movements, feedback from coaches, and processing operations) from the personal computer 360 or network-accessible server system 362.

The networked devices can be connected to the pose monitoring platform 352 via one or more networks. These networks can include PANs, LANs, WANS, MANs, cellular networks, the Internet, etc. Additionally or alternatively, the networked devices may communicate with one another over a short-range wireless connectivity technology. For example, if the pose monitoring platform 352 resides on the tablet computer 356, data may be obtained from the sensor units over a Bluetooth communication channel, while data may be obtained from the network-accessible server system 362 over the Internet via a Wi-Fi communication channel.

Embodiments of the communication environment 350 may include a subset of the networked devices. For example, some embodiments of the communication environment 350 include a pose monitoring platform 352 that obtains data from the therapy system 354 (and, more specifically, from the sensor units 358) in real time as physical activities as performed during a session and additional data from the network-accessible server system 352. This additional data may be obtained periodically (e.g., on a daily or weekly basis, or when a session is initiated).

### Pose Estimation Process

FIG. 4A depicts a flow diagram of a process 400A for updating a rendering of a target instance, according to one embodiment. The pose monitoring platform 102 can employ the process 400A as part of guiding a user through a set of physical activities for a session. In some embodiments, the pose monitoring platform 102 can perform additional or alternative steps to those shown in FIG. 4A and/or use additional or alternative modules to those described herein to perform the process 400A.

Initially, the avatar module 228 can obtain a digital image of an environment that is generated by the image sensor 210 (step 402). The digital image depicts a user in a predetermined pose in the environment of a computing device 200 that communicates with the pose monitoring platform 102. The predetermined pose can be an A-pose (e.g., where the user is standing up straight with arms at her sides) or a T-pose (e.g., where the user is standing up straight with her arms outstretched horizontally). In some embodiments, the avatar module 228 acquires the digital image directly from the image sensor 210, while in other embodiments the avatar module 228 acquires the digital image from the image database 232. The avatar module 228 constructs an avatar of the user based on the digital image (step 404). The avatar module 228 stores the avatar (or data describing the avatar) in the avatar database 236 in association with an identifier of the user and the digital image.

The rendering module 230 renders user interfaces for the session and causes the display mechanism 206 to display the interfaces to the user. The rendering module 230 can receive an indication to present an avatar performing a physical activity as part of the session or based on an indication of an input by the user via the display mechanism 206. The rendering module 230 retrieves the user's avatar from the avatar database 236. The rendering module 230 accesses poses and movements associated with the physical activity in the body part database 234 and renders a target instance of the avatar performing the physical activity (step 406). The target instance can be a combination of instances of the avatar performing the poses and movements need to achieve a particular pose or performance of the physical activity. The rendering module 230 causes the display mechanism 206 to display the target instance. The rendering module 230 can further cause the display mechanism to display an identifier of the physical activity, one or more of the poses or movements, and other orthogonal information about the physical activity or session.

The image sensor 210 captures movements of the user in the real world in image data of environment of the user (step 408). The rendering module 230 requests/retrieves the image data and sends the image data to the body pose module 224 to request estimated pose(s) being performed by the user. The body pose module 224 infers estimated pose(s) (and associated movements) of the user depicted by the image data. The rendering module 230 receives estimated pose(s) from the body pose module 224 and renders an inferred instance of the user's avatar performing the estimated pose(s) (step 410). The inferred instance can be a combination of instances of the avatar performing the estimated poses ordered by the body pose module 224 based on the image data and depicts the avatar mimicking the physical activity as performed by the user in the real world. The rendering module 230 causes the display mechanism 206 to display the inferred instance. The rendering module 230 can further cause the display mechanism to display information about how the user's performance of the physical activity. The rendering module 230 retrieves/requests new image data and again requests estimated pose(s) from the body pose module 224 using the image data. The rendering module 230 updates the inferred instance of the of the user's avatar to depict the newly received estimated pose(s) (step 412) and causes the display mechanism 206 to display the updated target instance to depict how the user performed the physical activity based on the new image data.

The process 400A may include additional or alternative steps to those shown in FIG. 4. For example, in some embodiments, the rendering module 230 causes the display mechanism 206 to display the target instance and the inferred instance at the same time, updating the inferred instance as the image data depicts the user attempting to perform the physical activity. In some embodiments, the rendering module 230 updates the target instance to focus on portions (e.g., poses and movements) of the physical activity that the user is not performing properly (e.g., the poses of the physical activity do not correspond to an estimated pose).

In some embodiments, the avatar module 228 obtains a digital image that is generated by the image sensor 210 included in the computing device 200. The avatar module 228 constructs, based on the digital image, an avatar of the user. The rendering module 230 renders, on the display mechanism 206 of the computing device 200, a target instance of the avatar in a pose. The image sensor 210 captures image data, in real-time, of movement of the user, and the body pose module 224 analyzes the image data to determine one or more poses and/or movements performed by the user. The rendering module 230 renders, on the display mechanism 206, an inferred instance of the avatar performing the one or more captured movements and/or estimated poses. The rendering module updates the rendering of the target instance to depict discrepancies between the pose and the one or more movements and/or estimated poses.

In some embodiments, the rendering module 230 renders the target instance and the inferred instance with the same visual effects, labels, and textures. For instance, the rendering module 230 can depict the target instance and the inferred instance avatar in the same clothes, with the same hairstyle, with labels of estimated poses and movements being performed, and the like.

FIG. 4B depicts a flow diagram of a process for rendering a second instance of a 3D avatar. The pose monitoring platform 102 can employ the process 400B as part of guiding a user through a set of physical activities for a session. In some embodiments, the pose monitoring platform 102 can perform additional or alternative steps to those shown in FIG. 4A and/or use additional or alternative modules to those described herein to perform the process 400B.

The avatar module 228 can obtain a digital image of an environment that is generated by the image sensor 210 (step 412). The avatar module 228 constructs an avatar of the user based on the digital image (step 414). The avatar module 228 stores the avatar (or data describing the avatar) in the avatar database 236 in association with an identifier of the user and the digital image.

The rendering module 230 can receive an indication to present an avatar performing a physical activity as part of the session or based on an indication of an input by the user via the display mechanism 206. The rendering module 230 retrieves the user's avatar from the avatar database 236. The rendering module 230 accesses poses and movements associated with a physical activity of the session in the body part database 234 and renders a first instance of the avatar performing the physical activity (step 416). The first instance can show the avatar in one pose or performing one movement or can be a combination of instances of the avatar performing the poses and movements of the physical activity. The rendering module 230 causes the display mechanism 206 to display the first instance.

The image sensor 210 captures movements of the user in the real world. The rendering module sends the image data to the image data to the body pose module 224 to request estimated pose(s) being performed by the user. The body pose module 224 infers estimated pose(s) (and associated movements) of the user depicted by the image data (step 418). The rendering module 230 receives estimated pose(s) from the body pose module 224 and renders a second instance of the user's avatar performing the estimated pose(s) and associated movements (step 420). The rendering module 230 causes the display mechanism 206 to display the second instance.

The process 400B may include additional or alternative steps to those shown in FIG. 4. For example, in some embodiments, the rendering module 230 causes the display mechanism 206 to depict the first instance and the second instance in the same visual space. The rendering module 230 can align the first and second instance based on corresponding reference points and poses.

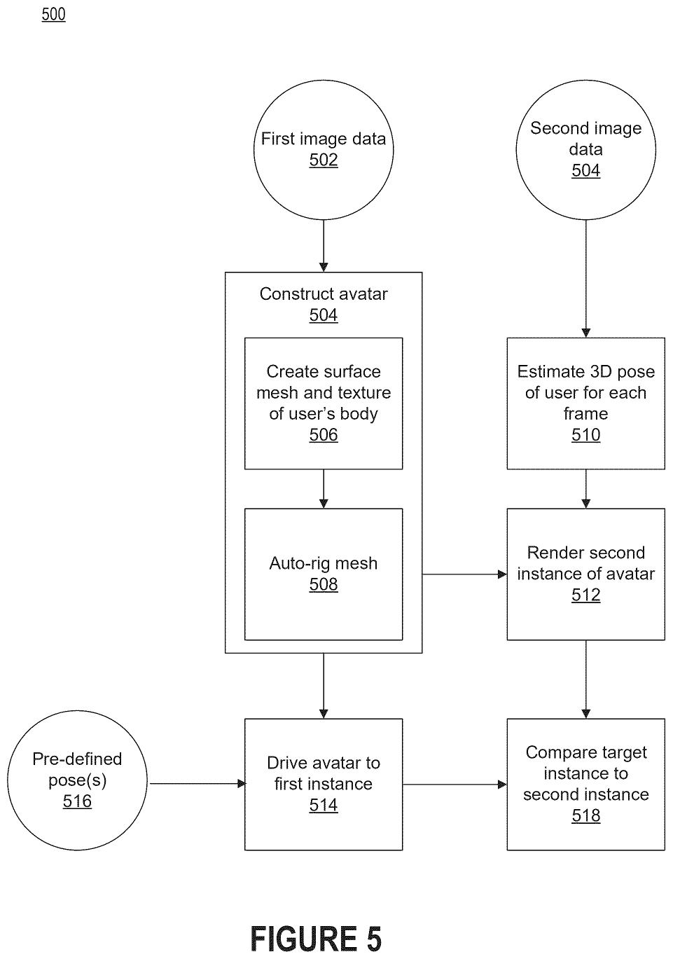

FIG. 5 depicts a flow diagram of a process 500 for comparing a first instance and a second instance. The pose monitoring platform 102 can employ the process 500 as part of guiding a user through a set of physical activities for a session. In some embodiments, the pose monitoring platform 102 can perform additional or alternative steps to those shown in FIG. 5 and/or use additional or alternative modules to those described herein to perform the process 500.

The avatar module 228 receives first image data 502. The first image data 502 can be a digital image, a set of digital images, a 3D body scan, video data, or the like and depicts a user of the pose monitoring platform 102. The avatar module 228 constructs an avatar of the user based on the first image data 502 (step 504). The avatar is a 2D or 3D representation of the user or the user's skeleton. The avatar module can use a capture engine to construct the avatar. The capture engine can be external to the computing device 200 of the image sensor 210 and can be a body scanner, an MVC engine, a light detection and ranging (LIDAR) system, or a multi-shot 3D reconstruction system. The avatar module 228 uses the capture engine to create a surface mesh of the first image data 502 (step 506). The avatar module 228 automatically rigs the surface mesh to create lifelike movement in the virtual representation of the user (e.g., to create the avatar) represented in the surface mesh (step 508). The avatar module 228 stores the avatar in the avatar database 236.

The rendering module 230 accesses pre-defined pose(s) 516 that related to a physical activity. In some instances, the rendering module 230 also receives movements associated with the pre-defined poses 516. The rendering module 230 accesses the user's avatar from the avatar database 236 and drives the avatar into a first instance performing the pre-determined pose(s) 516 (step 514). The first instance can also depict the avatar performing associated movements with the predetermined pose(s) 516. In some embodiments, the first instance may be referred to as a target instance of the avatar that shows how the user should perform the physical activity when using the correct technique.

The rendering module 230 accesses second image data 504. The second image data can be a set of digital images, video data, and the like and shows the user moving in an environment. The rendering module 230 sends the second image data 504 to the body pose module 224, which estimates a 3D pose being performed by the user in each frame of the second image data 504 (step 510). The rendering module 230 receives the 3D poses estimated by the body pose module 224 based on the second image data 504 and accesses the avatar of the user from the avatar database 236. The rendering module renders a second instance of the avatar in the 3D poses estimated by the body pose module 224. The second instance can also depict the avatar performing movement(s) associated with the estimated 3D poses. In some embodiments, the second instance may be referred to as an inferred instance of the avatar that shows how the user is performing the physical activity in the real world, which may include incorrect techniques of the poses or movements.

The rendering module 230 compares the first instance and the second instance (step 518). The rendering module 230 can analyze the instances based on joint position, bone angle and position, avatar volume, and the like and may analyze the instances frame by frame when the instances include movement. The rendering module 230 computes a comparison measure representing the similarity of the instances to one another and scores the user based on the comparison measure. The score may be a numerical value, a letter grade, or textual affirmations/instructions and may be based on a series of thresholds related to the value of the comparison measure. For example, if the comparison measure indicates that the instances have 98% similarity, the rendering module 230 can score the user with a “98,” an “A,” or a “good job.” In another example, if the comparison measure is less than 70%, the rendering module 230 can score the user with a “D” or “needs work.” The rendering module 230 can cause the display mechanism 206 to display the instances and/or the score.

The process 500 may include additional or alternative steps to those shown in FIG. 5. For example, in some embodiments, the rendering module 230 causes the display mechanism 206 to display the first instance and the second instance at the same time and updates the second instance upon receiving new image data depicting the user attempting to perform the physical activity. In some embodiments, the rendering module 230 updates the target instance to focus on portions (e.g., poses and movements) of the physical activity that the user is not performing properly.

### Pose Examples

FIG. 6A is a front view of a user in a T-pose, and FIG. 6B is an isometric view of an avatar in a T-pose. When in a T-pose, the user stands up straight with their feet together or about shoulder width apart. The user outstretches their arms to their sides, such that each arm is about parallel to the ground. The user keeps his neck straight and looks forward. The avatar module 228 can recognize a T-pose as predetermined pose that a user can mimic during capture of image data used to create their avatar. The avatar module 228 can also recognize an A-pose as another predetermined pose that the user can perform during capture of the image data for avatar creation. An A-pose is similar to a T-pose in that the user stands up straight with his feet together/should width apart. However, the user lets his arms hang by his sides such that his arms are about perpendicular to the ground, rather than parallel like in a T-pose.

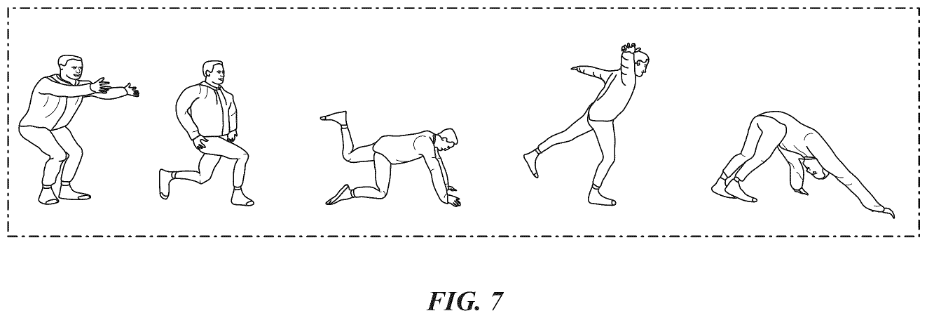

FIG. 7 depicts instances of an avatar of the user in a series of poses. For instance, the avatar module 228 created an avatar of the user based on digital images of the user as shown in FIGS. 6A-B. The rendering module 230 rendered the avatar in the series of poses using the avatar. The poses may have been estimated by the body pose module 224 based on image data captured of the user moving in an environment or based on poses associated with one or more physical activities. For example, the series of poses shown here can be part of a yoga session for the user. The rendering module 230 can cause the display mechanism 206 to display the avatar in each of the poses to guide the user through the session or to show the user the correct technique for doing the poses in the real world.

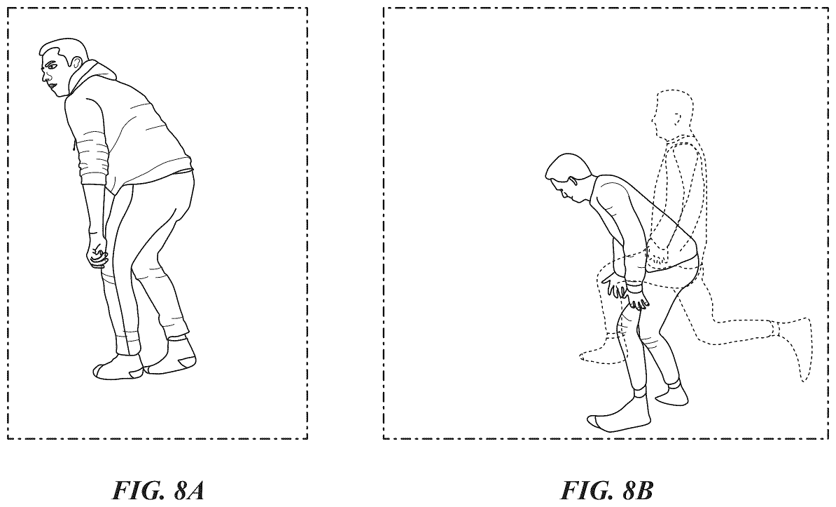

FIGS. 8A is an isometric view of a user in a bent pose. In FIG. 8A, the user is performing the bent pose in the real world, which is captured by the image sensor 210 and send to the rendering module 230. The rendering module 230 requests an estimated pose from the body pose module 224 based on the image in FIG. 8A. The rendering module 230 renders an inferred instance of the avatar of the user performing the estimated pose determined by the body pose module 224 (e.g., the bent pose). The rendering module 230 also renders a target instance of the user's avatar in a lunge pose, which is the physical activity the pose monitoring platform 10-2 is guiding the user to do. The rendering module 230 causes the display mechanism 206 to display the inferred instance and the target instance overlaid in the same visual space, as shown in FIG. 8B. Overlaying the instances allows the user to see, via the display mechanism 206, how he is performing the pose wrong and move to copy the pose shown by the target instance. The rendering module can update the inferred instance based on image data of the user moving in the real world and can update the target instance to depict the avatar in a new pose upon determining that the user has successfully performed the pose being currently shown by the target instance (e.g., by determining that a score based on a comparison measure of the instances is over a threshold).

### Processing System

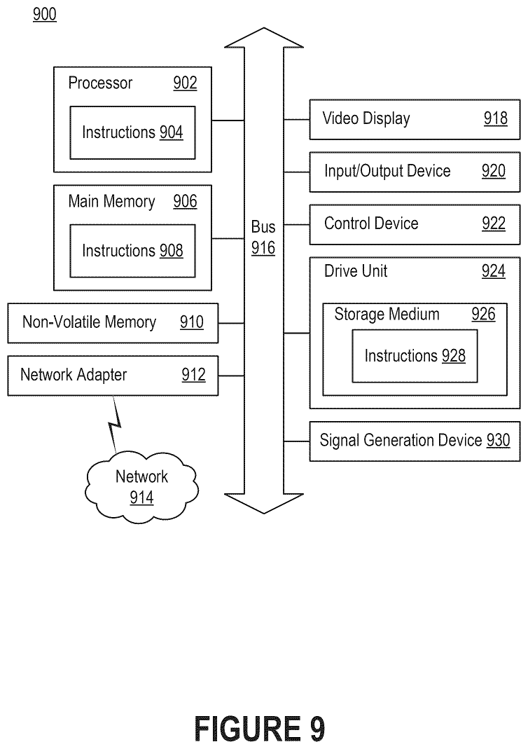

FIG. 9 is a block diagram illustrating an example of a processing system 900 in which at least some operations described herein can be implemented. For example, components of the processing system 900 may be hosted on a computing device that includes a pose monitoring platform (e.g., pose monitoring platform 102 of FIG. 1, pose monitoring platform 212 of FIG. 2, or pose monitoring platforms 302, 352 of FIGS. 3A-B).

The processing system 900 may include a processor 902, main memory 906, non-volatile memory 910, network adapter 912, video display 918, input/output device 920, control device 922 (e.g., a keyboard or pointing device), drive unit 924 including a storage medium 926, and signal generation device 930 that are communicatively connected to a bus 916. The bus 916 is illustrated as an abstraction that represents one or more physical buses or point-to-point connections that are connected by appropriate bridges, adapters, or controllers. The bus 916, therefore, can include a system bus, a Peripheral Component Interconnect (PCI) bus or PCI-Express bus, a HyperTransport or industry standard architecture (ISA) bus, a small computer system interface (SCSI) bus, a universal serial bus (USB), inter-integrated circuit (I2C) bus, or an Institute of Electrical and Electronics Engineers (IEEE) standard 1394 bus (also referred to as “Firewire”).

While the main memory 906, non-volatile memory 910, and storage medium 926 are shown to be a single medium, the terms “machine-readable medium” and “storage medium” should be taken to include a single medium or multiple media (e.g., a centralized/distributed database and/or associated caches and servers) that store one or more sets of instructions 928. The terms “machine-readable medium” and “storage medium” shall also be taken to include any medium that is capable of storing, encoding, or carrying a set of instructions for execution by the processing system 900.

In general, the routines executed to implement the embodiments of the disclosure may be implemented as part of an operating system or a specific application, component, program, object, module, or sequence of instructions (collectively referred to as “computer programs”). The computer programs typically comprise one or more instructions (e.g., instructions 904, 908, 928) set at various times in various memory and storage devices in a computing device. When read and executed by the processors 902, the instruction(s) cause the processing system 900 to perform operations to execute elements involving the various aspects of the present disclosure.

Further examples of machine-and computer-readable media include recordable-type media, such as volatile memory devices and non-volatile memory devices 910, removable disks, hard disk drives, and optical disks (e.g., Compact Disk Read-Only Memory (CD-ROMS) and Digital Versatile Disks (DVDs)), and transmission-type media, such as digital and analog communication links.

The network adapter 912 enables the processing system 900 to mediate data in a network 914 with an entity that is external to the processing system 900 through any communication protocol supported by the processing system 900 and the external entity. The network adapter 912 can include a network adaptor card, a wireless network interface card, a router, an access point, a wireless router, a switch, a multilayer switch, a protocol converter, a gateway, a bridge, bridge router, a hub, a digital media receiver, a repeater, or any combination thereof.

### Remarks

The foregoing description of various embodiments of the claimed subject matter has been provided for the purposes of illustration and description. It is not intended to be exhaustive or to limit the claimed subject matter to the precise forms disclosed. Many modifications and variations will be apparent to one skilled in the art. Embodiments were chosen and described in order to best describe the principles of the invention and its practical applications, thereby enabling those skilled in the relevant art to understand the claimed subject matter, the various embodiments, and the various modifications that are suited to the particular uses contemplated.

Although the Detailed Description describes certain embodiments and the best mode contemplated, the technology can be practiced in many ways no matter how detailed the Detailed Description appears. Embodiments may vary considerably in their implementation details, while still being encompassed by the specification. Particular terminology used when describing certain features or aspects of various embodiments should not be taken to imply that the terminology is being redefined herein to be restricted to any specific characteristics, features, or aspects of the technology with which that terminology is associated. In general, the terms used in the following claims should not be construed to limit the technology to the specific embodiments disclosed in the specification, unless those terms are explicitly defined herein. Accordingly, the actual scope of the technology encompasses not only the disclosed embodiments, but also all equivalent ways of practicing or implementing the embodiments.

The language used in the specification has been principally selected for readability and instructional purposes. It may not have been selected to delineate or circumscribe the subject matter. It is therefore intended that the scope of the technology be limited not by this Detailed Description, but rather by any claims that issue on an application based hereon. Accordingly, the disclosure of various embodiments is intended to be illustrative, but not limiting, of the scope of the technology as set forth in the following claims.

What is claimed is:

1. A method performed by a computer program executed on a computing device, the method comprising:
obtaining a digital image that is generated by an image sensor included in the computing device, wherein the digital image includes a user in a predetermined pose;
constructing a three-dimensional (3D) avatar based on the digital image;
rendering a first instance of the 3D avatar on an interface that is viewable on a display of the computing device, wherein the first instance provides a visual preview of one or more movements to be performed by the user to achieve a target pose;
inferring a pose of the user based on an analysis of movements of the user captured in real time;
rendering, based on the movements, a second instance of the 3D avatar on the interface, wherein the second instance is representative of the first instance deformed to account for the inferred pose;
wherein the first and second instances are rendered in the same 3D space to visually illustrate discrepancies, if any, between the inferred pose and the target pose.

2. A method performed by a computer program executing on a computing device, the method comprising:
obtaining a digital image that is generated by an image sensor included in the computing device;
constructing, based on the digital image, an avatar of a user using a capture engine;
rendering, on a display of the computing device, a target instance of the avatar, wherein the target instance depicts the avatar in a pose;
capturing, in real time, a movement of the user using a motion engine;
rendering, on the display, an inferred instance of the avatar based on the one or more captured movements; and
updating the rendering of the target instance to depict discrepancies between the one or more poses and the one or more movements.

3. The method of claim 3, wherein the digital image depicts the user in an A-pose or a T-pose.

4. The method of claim 2, wherein the capture engine is external to the computing device and is a body scanner, a light detection and ranging (LIDAR) system, or a multi-shot 3D reconstruction system.

5. The method of claim 2, wherein the motion engine is a 3D pose estimation engine, a motion capture device, or a motion sensor unit.

6. The method of claim 2, wherein the target instance and the inferred instance are rendered with the same visual effects, labels, and textures.

7. The method of claim 2, wherein the inferred instance and the target instance are rendering for display in the same visual space.

8. The method of claim 2, wherein the display includes orthogonal information describing the one or more poses.

9. The method of claim 2, wherein the target instance includes a first reference point associated with a body part of the avatar and the inferred target instance includes a second reference point associated with the same body part on the avatar, the method further comprising:
aligning the target instance and the inferred instance based on the first and second reference points; and
rotating the inferred target instance to align current poses of the first target instance and the inferred instance.

10. The method of claim 10, further comprising:
extracting position information from each of the target instance and the inferred instance;
computing a comparison measure between the position information of the target instance and the inferred instance; and
scoring the user based on the computed comparison measure.

11. The method of claim 11, wherein the position information represents underlying skeleton joint positions or bone angles and the comparison measure is one of absolute deviation or squared deviation.

12. The method of claim 12, wherein the position information represents avatar volume and the comparison is intersection over union of the position information.

13. The method of claim 12, further comprising:
sending the score to a second computing device associated with a professional, wherein the professional is a coach, physical therapist, or doctor.

14. The method of claim 12, wherein the display includes a virtual element representing the score.

15. The method of claim 12, wherein the avatar is a 3D representation of the user, a two-dimensional (2D) representation of the user, a 3D representation of the user's skeleton, or a 2D representation of the user's skeleton.

16. The method of claim 2, further comprising:
receiving real-time video data streamed from an environment of the user, wherein the real-time video data depicts the user performing the one or more movements.

17. The method of claim 2, wherein the display is embedded in an application on the computing device.

18. The method of claim 2, wherein the capture engine is external to the computing device and is a body scanner, a light detection and ranging (LIDAR) system, or a multi-shot 3D reconstruction system.

19. A system comprising:
a processor; and
a non-transitory computer-readable storage medium comprising instructions that when executed cause the processor to perform actions comprising:
obtaining a digital image that is generated by an image sensor included in the computing device;
constructing, based on the digital image, an avatar of a user using a capture engine;
rendering, on a display of the computing device, a target instance of the avatar, wherein the target instance depicts the avatar in one or more poses;
capturing, in real time, one or more movements of the user using a motion engine;
rendering, on the display, an inferred instance of the avatar based on the one or more captured movements; and
updating the rendering of the target instance to depict discrepancies between the one or more poses and the one or more movements.

20. The system of claim 19, wherein the digital image depicts the user in an A-pose or a T-pose.
